(19) United States
(12) Patent Application Publication
(10) Pub. No.: US 2001/0003175 A1
(43) Pub. Date: Jun. 7, 2001

(54) Apparatus and method for checking real name on internet

(76) Inventor: Yong-Nam Kim, Seongnam-city (KR)

Correspondence Address: Y. Rocky Tsao, Fish & Richardson P.C., 225 Franklin Street, Boston, MA, 02110-2804, US

(21) Appl. No.: 09/726,932

(22) Filed: Nov. 30, 2000

(30) Foreign Application Priority Data
Dec. 1, 1999 (KR) 1999-54264
Nov. 22, 2000 (KR) 2000-69728

(51) Int. Cl. G06F 17/60

(52) U.S. Cl. 705/1; 705/35; 705/72

(57) ABSTRACT

Disclosed is an apparatus and method for checking real names on the internet. The apparatus comprises a web unit for transmitting web pages to the user; a user management unit for receiving the user's personal information, transmitting the information to a bank, receiving a real name checking result from the bank, and checking the user's real name; and a database provided for the web unit and the user management unit. The bank transmits the user's real name checking message to a real name checking server when a real name checking code provided by the user who desires to open an account is identical with a code provided by the user management unit. The method comprises the steps of receiving personal information from a user; transmitting a real name checking code to the user and storing the real name checking code; transmitting the personal information and the real name checking code to a bank; and receiving a real name checking result from the bank.

### BACKGROUND OF THE INVENTION

1. Field of the Invention

The present invention relates to an apparatus and method for checking real names on the Internet. More specifically, the present invention relates to an apparatus and method for checking real names of members registered via web pages.

2. Description of the Related Art

As information telecommunication and computer techniques have greatly developed, people have also become to share various sorts of information overcoming restrictions of time and space. This information sharing has been executed focusing on the Internet, and the amount of apparatus and information connected to the Internet has rapidly increased.

The Internet totally depends on information inputted by a subscriber in the web site for checking a web site member's real name.

Therefore, in the case of adult sites or financial service providing sites that require a confirmation process on the member's real name, it is not reliable whether the information input by the member on the web sites is the member's real name.

### SUMMARY OF THE INVENTION

It is an objective of the present invention to provide a real name checking apparatus and method for determining real names provided by members on the web pages.

In one aspect of the present invention, an apparatus for checking a user's real name on a network comprises three parts; 1) a web unit for transmitting web pages to the user, 2) a user management unit for receiving the user's personal information, transmitting the information to a bank, receiving a real name checking result from the bank, and checking the user's real name, and 3) a database provided for the web unit and the user management unit.

The bank transmits the user's real name checking message to a real name checking server when a real name checking code provided by the user who desires to open an account is identical with a code provided by the user management unit.

In another aspect of the present invention, a method for checking a user's real name on a network comprises the steps of: (a) receiving personal information from a user; (b) transmitting a real name checking code to the user and storing the real name checking code; (c) transmitting the personal information and the real name checking code to a bank; and (d) receiving a real name checking result from the bank.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a real name checking system according to a preferred embodiment of the present invention;

FIG. 2 shows a detailed configuration of a real name checking server according to a preferred embodiment of the present invention; and

FIG. 3 shows a flow chart of a real name checking method according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention can be modified in various obvious respects, all without departing from the invention. Accordingly, the drawings and description are to be regarded as illustrative in nature, and not restrictive.

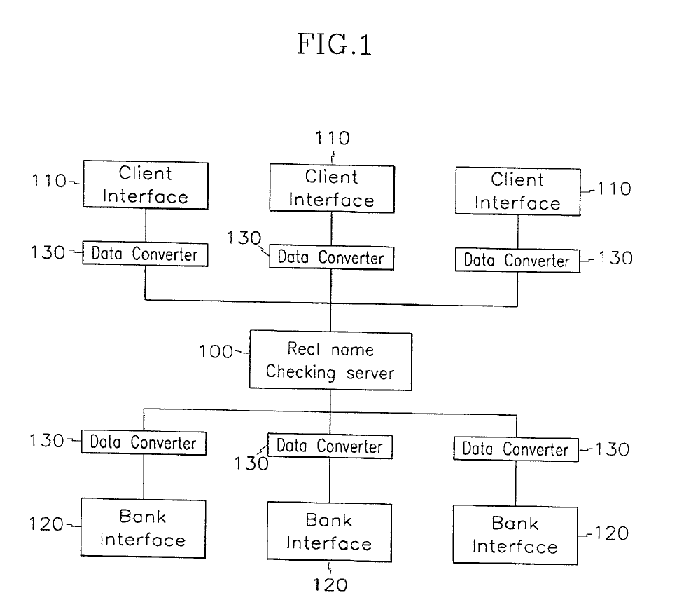

FIG. 1 shows a block diagram of a real name checking system according to a preferred embodiment of the present invention.

As shown, the real name checking system comprises a real name checking server 100, a client interface 110 and a bank interface 120.

The client interface 110 is an interface provided to a client who desires to check his real name after registering as a member. The client interface includes a random bidirectional communication network terminal, for example, a web browser displayed on the client's computer.

The bank interface 120 is an interface provided to a bank for checking the clients' real names. The client interface includes a random bidirectional communication network terminal, for example, a web browser displayed on the bank's computer.

The above-noted interfaces 110 and 120 are connected via the real name checking server 100 and the Internet using the public switched telephone network (PSTN) and the local area network (LAN). The connection can be executed via PCS and satellite communication as well as wire communication.

The respective interfaces additionally comprise a data converter 130 for transmitting and receiving data to/from the real name checking server 100. The data converter 130 can comprise a modem for converting data to transmit via the network provided between the interface and the real name checking server, or a LAN card.

The real name checking server 100 can comprise a web server configured for executing real name checking processes, and the web server can comprise a configuration unit for starting a homepage and sending and receiving mails.

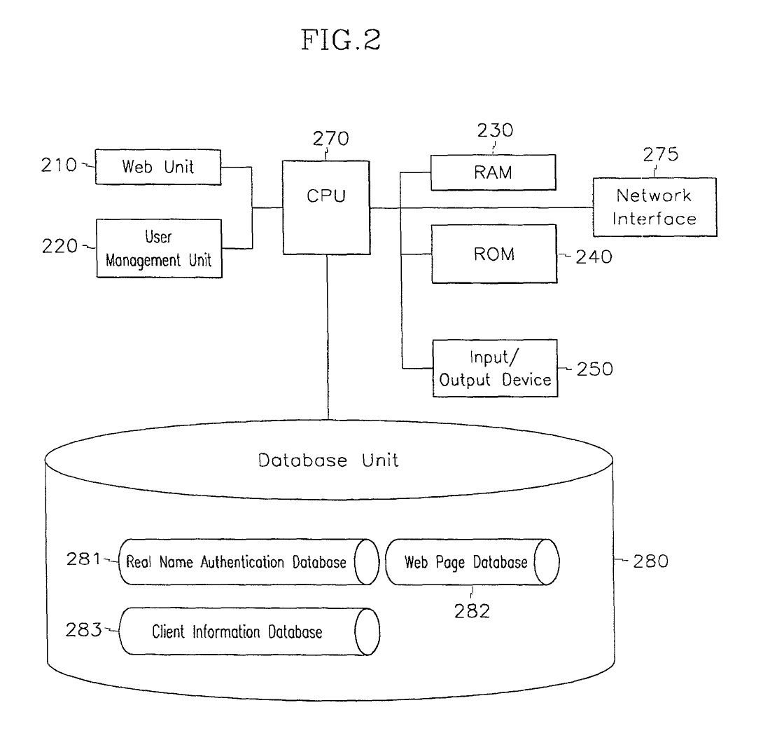

FIG. 2 shows a detailed configuration of a real name checking server according to a preferred embodiment of the present invention.

As shown, the real name checking server 100 comprises a web unit 210, a user management unit 220, a first memory 230, a second memory 240, an input/output device 250, a central processing unit (CPU) 270 and a database unit 280. The CPU 270 processes all the configuration units, and is connected to the client and bank interfaces 110 and 120 via a network interface 275.

The web unit 210, when a user inputs a uniform resource location (URL) of a web page via a web browser to the web unit 210, reads a web page corresponding to the URL from a web page database and transmits the same to the user's web browser to be displayed.

The user management unit 220, when the service user's personal information is inputted through the web page displayed on the user's web browser, stores the user's personal information and provides a real name checking code to the user and concurrently transmits the user's personal information to the bank so as to check the user's real name, and when the user checks his real name using the real name checking code at the bank and opens an account, the user receives a real name checking result from the bank.

At this time, the personal information includes member IDs, passwords and resident identification numbers, and the ID or the resident identification number can be used instead of the real name checking code.

The database unit 280 comprises a real name authentication database 281 for storing and managing real name authentication data, a web page database 282 for storing and managing web pages that provides services, and a client information database 283 for storing and managing the clients' personal information.

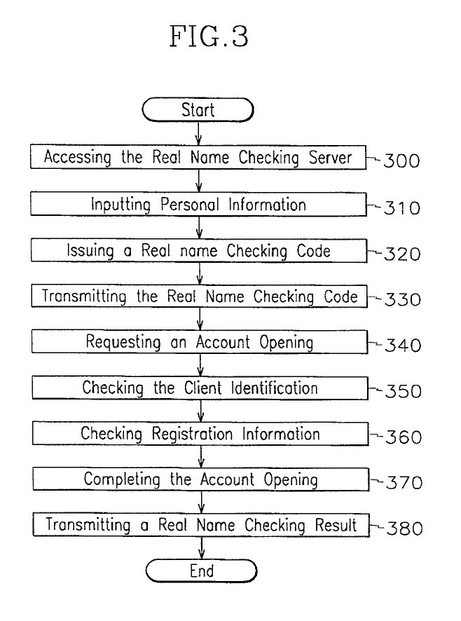

FIG. 3 shows a flow chart of a real name checking method according to a preferred embodiment of the present invention.

The user accesses the real name checking server in step S300. The user inputs a URL of a desired web page to the web browser installed in the terminal, and the web browser outputs the URL to the web unit 210. After receiving the URL signal, the web unit 210 transmits corresponding web pages to the user through the network interface 275, and the web pages are displayed via the web browser.

When the web pages are displayed on the web browser, the user inputs his personal information in the information filling blanks of the web pages in step S310. The personal information is transmitted to the real name checking server 100 and stored in the client information database 283.

When receiving the personal information from the user, the real name checking server 100 issues a real name checking code that the personal information is inputted, to the user in step S320. The real name checking server 100 stores the code in the real name authentication database 281.

The real name checking server 100 transmits the personal information and the code to the bank via the network interface 275 in step S330.

When receiving the code, the user requests an account opening at the bank in step S340.

The bank checks the user's identification in step S350.

After checking the user's identification, the bank checks the personal information registered by the user at the real name checking server 100 in step S360.

The bank checks registration information made by the user at time of requesting an account opening, and checks whether the registration information is identical with the personal information input by the user at the real name checking server 100 and the real name checking code received from the user management unit 220, and when they are identical, the bank opens an account to the user in step S370.

After opening an account to the user, the bank transmits a real name checking result to the real name checking server 100 in step S380. When receiving the real name checking result from the bank, the real name checking server finishes the user's real name checking process.

According to the preferred embodiment, since personal information provided by the user is checked by a real name checking process at time of opening a bank account, the user's information can be guaranteed.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. In an apparatus for checking a user's real name on a network, an apparatus for checking a user's real name on a network, comprising:
a web unit for transmitting web pages to the user;
a user management unit for receiving the user's personal information, transmitting the information to a bank, receiving a real name checking result from the bank, and checking the user's real name; and
a database provided for the web unit and the user management unit.

2. The apparatus of claim 1, wherein the bank transmits the user's real name checking message to a real name checking server when a real name checking code provided by the user who desires to open an account is identical with a code provided by the user management unit.

3. The apparatus of claim 1, wherein the personal information comprises an identification (ID), password and resident identification number.

4. The apparatus of claim 2, wherein a resident identification number can be used instead of the real name checking code.

5. The apparatus of claim 2, wherein an identification (ID) can be used instead of the real name checking code.

6. The apparatus of claim 2, wherein the real name checking code is used as a banking account number.

7. In a method for checking a user's real name on a network, a method for checking a user's real name on the network, comprising the steps of:
(a) receiving personal information from a user;
(b) transmitting a real name checking code to the user and storing the real name checking code;
(c) transmitting the personal information and the real name checking code to a bank; and
(d) receiving a real name checking result from the bank.

8. The method of claim 7, wherein the personal information comprises an identification (ID), password and resident identification number.

9. The method of claim 7, wherein a resident identification number can be used instead of the real name checking code.

10. The method of claim 7, wherein an identification (ID) can be used instead of the real name checking code.

11. The method of claim 7, wherein the real name checking code is used as a banking account number.

12. In a method for checking a real name at a bank, a method for checking a real name on a network of the bank, comprising the steps of:
the bank receiving an account opening request from a user;
the bank checking the user's identification;
the bank checking registration information, the registration information being made by the user when requesting an account opening;
the bank determining whether the registration information is identical with the personal information provided by the user and the real name checking code provided by a user management unit;
the bank opening an account to the user when the registration information is identical with the personal information provided by the user and the real name checking code provided by the user management unit; and
the bank transmitting a real name checking result to a real name checking server.
